(19) United States
(12) Patent Application Publication
(10) Pub. No.: US 2004/0203881 A1
(43) Pub. Date: Oct. 14, 2004

(54) Method and apparatus for providing phase coherent communication in a wireless communication system

(76) Inventor: Billy G. Echols JR., Jackson, MS (US)

Correspondence Address: David O'Neill, WorldCom, Inc., Technology Law Department, 1133 19th Street NW, Washington, DC, 20036, US

(21) Appl. No.: 10/291,968

(22) Filed: Nov. 12, 2002

(51) Int. Cl. H04Q 7/20

(52) U.S. Cl. 455/456.1; 455/466

(57) ABSTRACT

A method and system for providing phase coherent communication in a wireless communication system. The wireless communication system allocates a predetermined number of launch sites for transmitting a message to a target site. A distance is determined between each of the launch sites and the target site, and a carrier frequency is determined to be respectively used by each of the predetermined number of launch sites. The message is transmitted from the predetermined number of launch sites to the target site using the respective carrier frequency determined for each of the predetermined number of launch sites.

### BACKGROUND OF THE INVENTION

1. Field of the Invention

This invention relates generally to wireless communication networks and, more particularly, to a method and apparatus for providing phase coherent communication within a wireless communication network.

2. Description of the Related Art

Wireless communication networks, such as radio communication networks, have become increasingly popular over the years due in part to the freedom of movement they provide to the communicating public. As a result of this popularity, wireless communication networks have rapidly expanded, and are commonly used to transmit voice and/or data communication without the need to be tethered to a particular location.

One particular area of concern for wireless communication systems, however, has been the security of the voice and/or data communicated within the system. Because this communication is transmitted over the air, it is typically more prone to interception by an unauthorized third party, as opposed to a hard-wired link, for example, which tends to be more secure.

To provide a more secure means of wireless transmission, some wireless communication systems employ encryption algorithms. However, once the wireless signal is intercepted by an unauthorized party, it is usually just a matter of time before the encryption algorithm is ascertained and the voice and/or data can be decoded by the unauthorized party.

The present invention is directed to overcoming, or at least reducing the effects of, one or more of the problems set forth above.

### SUMMARY OF THE INVENTION

One aspect of the present invention is seen in a method. The method comprises selecting a plurality of launch sites for transmitting a message to a target site and determining a distance between each of the launch sites and the target site. A carrier frequency is determined to be respectively used by each of the launch sites. The carrier frequency is different for each respective launch site. The message is transmitted from the launch sites to the target site using the respective carrier frequency determined for each of the plurality of launch sites.

Another aspect of the present invention is seen in a wireless communication system. The system comprises a plurality of launch sites for transmitting a message, a switch coupling the plurality of launch sites, and a target site for receiving the message via a wireless communication link. The switch selects the plurality of launch sites for transmitting a message to a target site, determines a distance between each of the launch sites and the target site, and determines a carrier frequency to be respectively used by each of the launch sites. The carrier frequency is different for each respective launch site. The launch sites transmit the message to the target site using the respective carrier frequency determined for each of the plurality of launch sites.

### BRIEF DESCRIPTION OF THE DRAWINGS

The invention may be understood by reference to the following description taken in conjunction with the accompanying drawings, in which like reference numerals identify like elements, and in which:

FIG. 1 shows a wireless communication network including a plurality of launch sites communicating a secure wireless transmission to a target site according to one embodiment of the present invention;

FIG. 2 illustrates a block diagram of one of the plurality of launch sites of the wireless communication network of FIG. 1;

FIG. 3 depicts a block diagram of the target site of the wireless communication network of FIG. 1;

FIG. 4 shows a block diagram of a target control point, which controls the plurality of launch sites of the wireless communication network of FIG. 1;

FIG. 5 is a diagram illustrating the differences between the carrier frequencies assigned to each of the plurality of launch sites; and

FIG. 6 illustrates a process for performing phase coherent communication in the wireless communication system of FIG. 1 according to one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

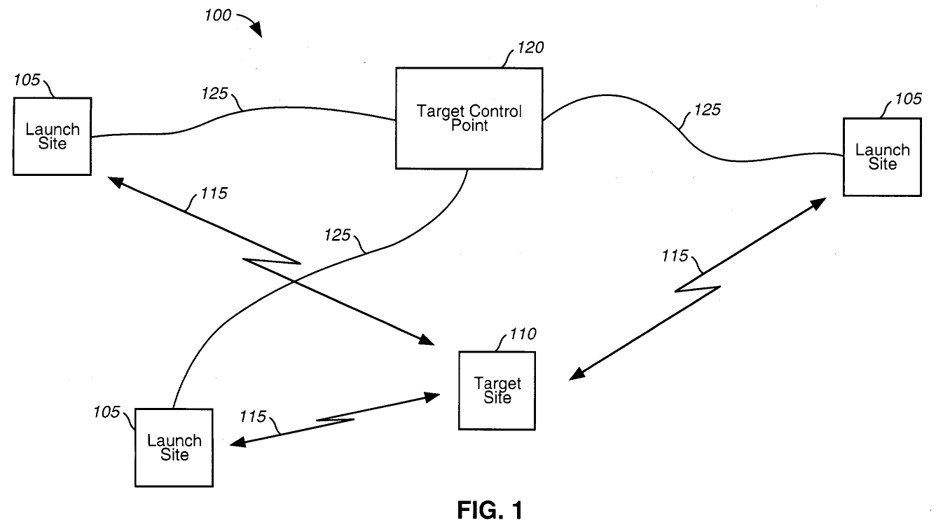

Turning now to the drawings, and specifically referring to FIG. 1, a wireless communication system 100 is shown in accordance with one embodiment of the present invention. In the illustrated embodiment, the wireless communication system 100 takes the form of a secure radio frequency (RF) communication system that transmits data in accordance with one of a plurality RF modulation protocols. The particular RF modulation protocols used may include amplitude modulation (AM), frequency modulation (FM), phase modulation (PM), ultra wide band (UWB) modulation, etc. It will be appreciated that a variety of other modulation protocols may be used in addition to or in lieu of the aforementioned protocols without departing from the spirit and scope of the present invention.

The wireless communication system 100 comprises a plurality of launch sites (LS) 105 that communicate with at least one target site (TS) 110. The launch sites 105 are deployed in various geographical locations throughout the wireless communication system 100 and communicate data with the target site 110 via a respective radio frequency (RF) communication link 115. Although only a total of three launch sites 105 are illustrated in FIG. 1, it will be appreciated that the communication system 100 may employ a larger number of launch sites 105 without departing from the spirit and scope of the present invention. Furthermore, the plurality of launch sites 105 that are chosen to transmit the secure data with the target site 110 have differing azimuths in relation to the target site 110 in accordance with the illustrated embodiment.

Each of the launch sites 105 are controlled by a target control point (TCP) 120, and are linked thereto by communication lines 125. In accordance with one embodiment, the communication lines 125 take the form of wired communication lines that couple the launch sites 105 to the target control point 120. It will be appreciated, however, that the communication lines 125 may also take the form of a wireless link, such as an RF communication link or satellite link, for example, without departing from the spirit and scope of the present invention. In accordance with one embodiment of the present invention, the launch sites 105 and the target site 110 are geographically stationary; however, the target site 110 and/or launch sites 105 may be mobile or re-located throughout the communication system 100 (i.e., the geographical position of the launch and/or target sites 105, 110 may change within the wireless communication system 100 at various points in time). In accordance with one embodiment of the present invention, the target site 110 may take the form of a submarine or surface ship, for example, in which it is desired to transmit secure communication to the target site 110 at predetermined locations. In another application, the target site 110 may take the form of an automated teller machine (ATM), which receives secure communication from the launch sites 105 regarding a user's confidential banking information, for example. It will be appreciated, however, that the target site 110 may take the form of any mobile or stationary object where secure communication is desired between the launch sites 105 and the target site 110, and, thus need not necessarily be limited to the aforementioned examples.

Data and/or voice communication may be transmitted from certain launch sites 105 to the target site 110 over the RF communication links 1 15 under control of the target control point 120. The target control point 120 divides the secure information (i.e., payload) that is to be transmitted to the target site 110 amongst a plurality of the launch sites 105 for transmission of the payload into three or more RF bit streams. In accordance with one embodiment, each RF bit stream may be configured with a forward error correcting (FEC) algorithm to reduce the effects of transmission errors. All the RF bit streams containing intelligence that are transmitted from the launch sites 105 are needed for reception at the target site 110 to have the transmitted data properly decoded. Other launch sites may be used to transmit non-coherent, non-phased data used to further obfuscate the desired intelligence. Accordingly, if the data transmitted from one particular launch site 105 is intercepted by an unauthorized third party, only a portion of the secure information would have been intercepted and not the entire secure message (i.e., the entire payload would not be received by the unauthorized party). When each portion of the divided payload is transmitted and received at the target site 110 from the launch sites 105 over their respective RF communication links 115, the divided payload is reassembled at the target site 110 and processed by the target site 110 in its entirety. The dividing of the secure information by the target control point 120 into a plurality of RF bit streams for transmission by the launch sites 105 and the subsequent re-assembly may be accomplished by synchronously encoding a three-level bit (one bit per carrier) into the RF stream. If the power is missing in a slot, it is assumed to be a ‘zero’ and if there is power in a slot, it is assumed to be a ‘one’. Therefore, there is distributed three bits per baud, or eight distinct characters, when using three carriers. The number of carriers and bits per baud may be expandable by powers of two. For example, five carriers would present 32 distinct states while seven carriers would present 128 characters (enough for the ASCII character set, for example). Frequency shift keying (FSK), binary phase shift keying (BPSK), quadrature phase shift keying (QPSK), or even high speed Morse code may also be used as modulation schemes on each carrier transmitted from the launch sites 105.

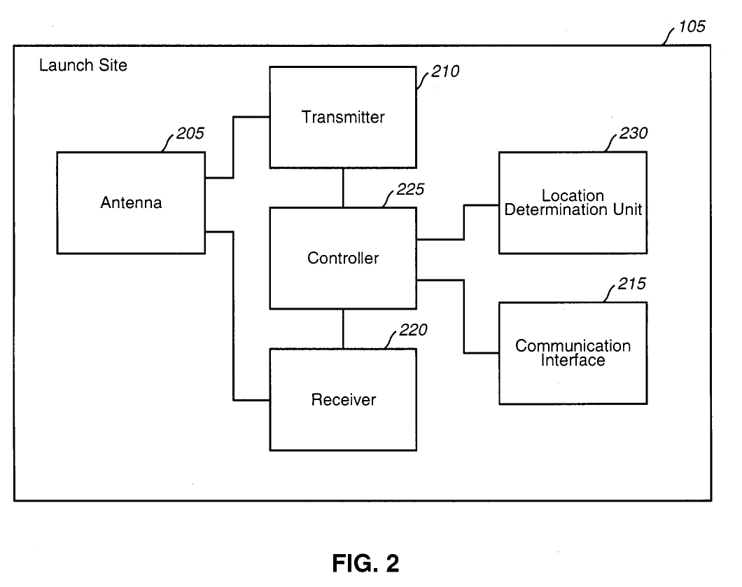

Turning now to FIG. 2, a more detailed representation of the launch site 105 is shown in accordance with one embodiment of the present invention. Although the launch site 105 provided in FIG. 2 is shown in one of its simplest forms for ease in illustrating the present invention, it will be appreciated that the launch site 105 may include several other components either in addition to or in lieu of those components illustrated without departing from the spirit and scope of the present invention.

The launch site 105 includes an antenna 205 for transmitting the divided payload to the target site 110 via a wireless communication protocol, which, in accordance with the illustrated embodiment, takes the form of a RF bit stream. A transmitter 210 transmits the RF bit stream to the target site 110 that is received from the target control point 120 via a communication interface 215, which communicatively couples the launch site 105 to the target control point 120. The launch site 105 may further be configured with a receiver 220 for receiving communication transmitted from the target site 110. Upon receiving communication from the target site 110, the received communication is forwarded to the communication interface 215 for transmission to the target control point 120. A controller 225 is provided to control the operation of the launch site 105 and its internal components. The launch site 105 is further configured with a location determination unit 230, which provides the geographical location of the launch site 105 within the wireless communication system 100. In accordance with one embodiment of the present invention, the location determination unit 230 takes the form of a global positioning system (GPS), such as NAVSTAR, for example, for obtaining the geographical coordinates of the launch site 105. It will be appreciated, however, that the location determination unit 230 may take the form of various other commercially available geographical location systems without departing from the spirit and scope of the present invention. The significance of the location determination unit 230 will be appreciated as the detailed description proceeds.

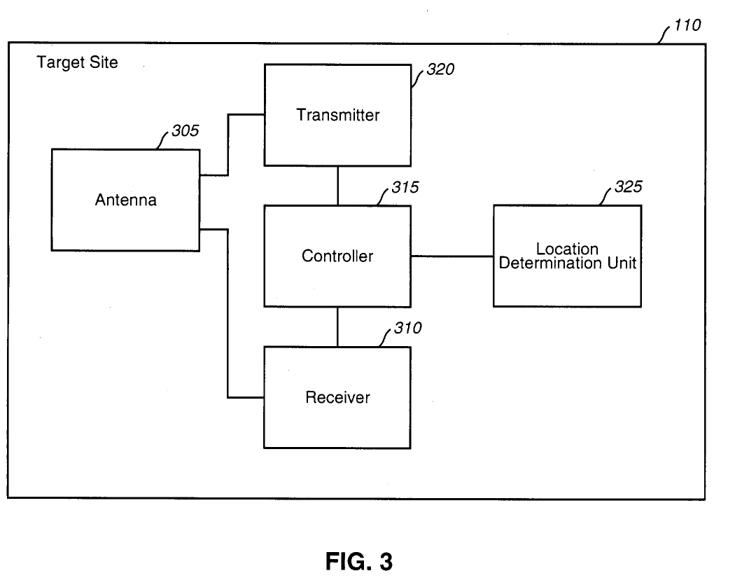

Turning now to FIG. 3, a more detailed representation of the target site 110 is shown in accordance with one embodiment of the present invention. Although the target site 110 provided in FIG. 3 is shown in one of its simplest forms for ease in illustrating the present invention, it will be appreciated that the target site 110 may include several other components either in addition to or in lieu of those components illustrated without departing from the spirit and scope of the present invention. Furthermore, the target site 110 may take the form of various mobile or stationary objects in which it is desired to receive secure communication.

The target site 110 includes an antenna 305 for receiving communication from the launch site 105 via a wireless communication protocol, which takes the form of an RF bit stream in accordance with the illustrated embodiment. The target site 110 is configured with a receiver 310 for receiving the RF bit streams that are transmitted from the launch sites 105. The target site 110 may also be configured with a transmitter 320 for transmitting a response signal to one or more launch sites 105 in response to receiving the RF bit streams that were transmitted by the plurality of launch sites 105. For example, the response signal may provide an acknowledgement to a particular launch site 105 that its transmitted RF bit stream was successfully received at the target site 110. The target site 110 may also transmit an acknowledgement to indicate that the secure message from the plurality of launch sites 105 was properly decoded.

The target site 110 is further configured with a controller 315, which controls the overall operation of the target site 110 and its internal components. The target site 105 is further configured with a location determination unit 325, which provides the geographical location of the target site 110 within the communication system 100. In accordance with one embodiment of the present invention, the location determination unit 325 takes the form of a global positioning system (GPS), such as NAVSTAR, for example, for obtaining the geographical coordinates of the target site 110. It will be appreciated, however, that the location determination unit 325 may take the form of various other commercially available geographical location systems without departing from the spirit and scope of the present invention.

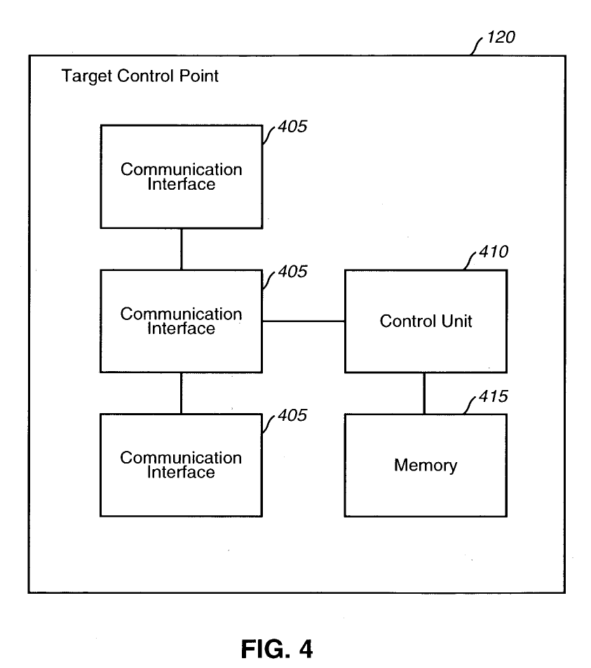

Turning now to FIG. 4, a more detailed representation of the target control point 120 is shown in accordance with one embodiment of the present invention. Although the target control point 120 provided in FIG. 4 is shown in one of its simplest forms for ease in illustrating the present invention, it will be appreciated that the target control point 120 may include several other components either in addition to or in lieu of those components illustrated without departing from the spirit and scope of the present invention.

The target control point 120 comprises a plurality of communication interfaces 405, which enable communication with the plurality of launch sites 105 via the communication lines 125. The number of communication interfaces 405 may vary depending on the number of launch sites 105 that are communicatively coupled to the target control point 120, but in one embodiment, the number of communication interfaces 405 of the target control point 120 corresponds directly to the number of launch sites 105 coupled thereto.

The communication interfaces 405 are configured to transmit each of the RF bit streams of the divided payload to the respective launch site 105. The communication interfaces 405 are also configured to receive data from each of the launch sites 105 that are coupled thereto. For example, the data received from the launch sites 105 may include geographical coordinate location data that is derived from the location determination unit 230 in each respective launch site 105. The geographical coordinate data of the target site 110 may also be sent to the target control point 120 via one of the plurality of launch sites 105. In an alternative embodiment, the target control point 120 may be configured with a radio receiver (not shown) to receive the geographical coordinate data from the target site 110 directly.

The target control point 120 is further configured with a control unit 410 for controlling the overall operation of the target control point 120. A memory 415 may also be provided to store instruction sets for instructing the control unit 410 and for storing data, such as the launch sites' 105 and target site's 110 geographical coordinate data, for example.

If the phase of a transmitted RF bit stream modulated on a particular carrier frequency is 90 degrees at the location of one of the launch sites 105, then at a distance x away from the launch site 105 the phase of the transmitted RF bit stream will again be at 90 degrees. At no other physical point on the route from the launch site 105 to the distance x away from the launch site 105 may the phase of 90 degrees be measured for the transmitted bit stream on the particular carrier frequency used. This pattern of a 90-degree phase measurement every distance x repeats until the power contained in the transmitted RF bit stream decreases into the noise and becomes immeasurable and unusable. The number of times the same phase of the transmitted signal from the launch site 105 repeats itself depends on the carrier frequency selected on which to modulate the RF bit stream. That is, the higher the carrier frequency, the shorter the wavelength of the transmitted signal, and, thus, the number of times the same phase of the signal repeats itself over a particular distance is increased. Conversely, the lower the carrier frequency selected, the longer the wavelength of the transmitted signal, and, thus, the number of times the same phase of the signal repeats itself over a particular distance is reduced.

It is desirable to select the carrier frequencies for each of the plurality of launch sites 105 such that each of the transmitted signals from the launch sites 105 are “in-phase” at the location of the target site 110. That is, the target site 110 is able to receive the RF bit streams transmitted from the plurality of launch sites 105 when all of the transmitted signals from the launch sites 105 have the same phase. Additionally, the carrier frequencies of the launch sites 105 are selected such that all of the transmitted signals are only in phase at the site of the target site 110, thereby significantly reducing the likelihood that the secure message that is transmitted to the target site 110 cannot be intercepted by an unauthorized third party along other points between the plurality of launch sites 105 and the target site 110.

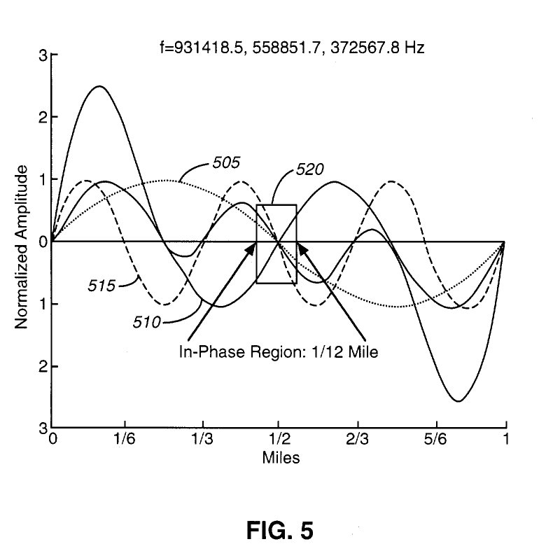

Turning now to FIG. 5, an example of three carrier frequencies selected for each of the three launch sites 105 of the wireless communication system 100 plotted over a one mile distance is shown. It will be appreciated that the number of launch sites 165 used to transmit the secure message to the target site 110 may vary. Accordingly, if the target control point 120 selects four launch sites 105 to transmit the secure message, four distinct carrier frequencies would be determined, one carrier frequency for each launch site 105. Additionally, the particular carrier frequencies used will depend on the distance between each of the launch sites 105 and the target site 110, and, thus need not be limited to the particular examples illustrated.

As shown in FIG. 5, the differences (i.e., beats) between the three exemplary carrier frequencies, 931,419.5 Hz (f1), 558,851.7 Hz (f2), and 372,567.8 Hz (f3) that are to be used by the respective launch sites 105 of FIG. 1 is shown. The line designated by reference numeral 505 is the carrier frequency f2 minus the carrier frequency B3, the line designated by reference numeral 510 is the carrier frequency f1 minus the carrier frequency f2, and the line designated by reference numeral 515 is the carrier frequency f1 minus the carrier frequency f3. The three beat frequencies are exactly in phase when transmitted from their respective launch sites 105 (shown on the left of the graph), at the half-wave point of the lowest frequency f3 (shown in the middle), and at exactly one mile (shown on the right). At all other points, the carriers are out of phase.

A coherence circle designated by reference numeral 520 (FIG. 5) is formed when all of the carrier frequencies of the launch sites 105 are in phase. The location of the coherence circle 520 is the same location as the target site 110 such that the target site 110 is able to receive all of the transmitted RF bit streams from each of the launch sites 105 when their respective carrier frequencies are all in phase within the coherence circle 520. In the particular example shown in FIG. 5, the coherence circle 520 has a diameter of 1/12^{th} of a mile. The diameter of the coherence circle 520 may be determined by taking ¼^{th} the wavelength (+/− 45 degrees or 90 degrees) at the highest beat frequency. In the example provided, 186,283.9 divided by the carrier frequency f1 minus the carrier frequency f3 equals 0.3333 miles times 5,280 feet, which equals 1,760 feet times ¼^{th}, which equals 440 feet or 1/12^{th} of a mile. Therefore, the coherence circle diameter in feet equals 983,578,992/ (4* (highest frequency−lowest frequency)). At no other point between the location of the launch sites 105 and the target site 110 are the carrier frequencies in phase. The coherence circle 520 is located at the location of the target site 110, and the carrier frequencies transmitted by each respective launch site 105 is selected such that all of the transmitted signals will be in phase within the coherence circle 520. Accordingly, the likelihood of an unauthorized third party from intercepting each of the RF bit stream transmissions at any other point between the launch sites 105 and the target site 110 (i.e., being located outside of the coherence circle 520) is significantly reduced.

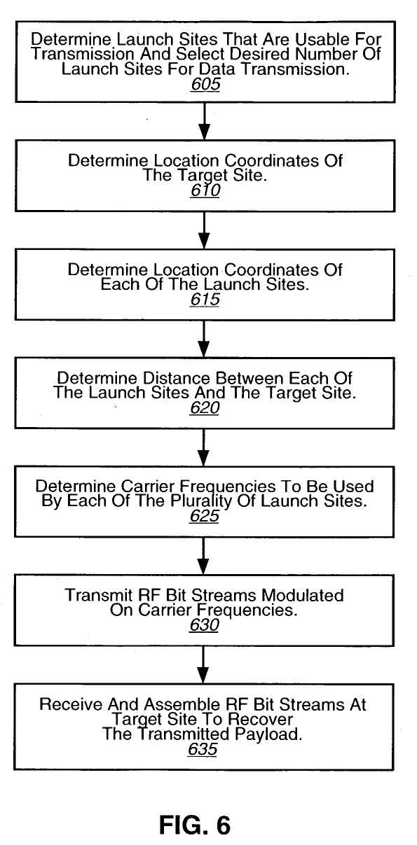

Turning now to FIG. 6, a process 600 for providing phase coherent communication in the wireless communication system 100 is provided according to one embodiment of the present invention. The process 600 commences at block 605 where the target control point 120 determines the number of launch sites 105 that are coupled thereto and that are usable for the transmission of the payload to the target site 110. Once the target control point 120 determines the number of launch sites 105 that are usable for data transmission, the target control point 120 determines which launch sites 105 to use to transmit the data to the target site 110. That is, the payload is divided into a number of RF bit streams that correspond to the number of launch sites 105 that will transmit the data. Each of the RF bit streams are respectively transmitted from the launch sites 105 that were selected by the target control point 120 to transmit the payload to the target site 110. Certain launch sites 105 of the communication system 100 may be designated by the target control point 120 as a “dummy” launch site, which transmits data to the target site 110, but the data that is transmitted by the dummy launch site is uncorrelated to the secure data that is transmitted to the target site 110 by the launch sites 105 that were selected by the target control point 120.

At block 610, the location coordinates of the target site 110 is determined at a particular point in time. In accordance with one embodiment of the present invention, the location coordinates of the target site 110 may be determined by the location determination unit 325 resident within the target site 110. According to the illustrated embodiment, the location determination unit 325 takes the form of a GPS receiver, which receives timing signals from satellites (not shown) to determine the precise position of the target site 110 by providing its geographical location coordinates in accordance with methods that are established in the art. It will be appreciated, however, that the location determination unit 325 may employ various other commercially available positioning location systems without departing from the spirit and scope of the present invention.

The location coordinates of each of the launch sites 105 is also determined by the location determination unit 230 that is resident within each of the plurality of launch sites 105 at block 615. In accordance with one embodiment of the present invention, the location determination unit 230 takes the form of a GPS receiver; however, the location determination unit 230 of each launch site 105 may also employ various other commercially available positioning location systems without departing from the spirit and scope of the present invention.

At block 620, the distance is determined between each of the plurality launch sites 105 and the target site 110. In accordance with one embodiment of the present invention, the distance between each of the launch sites 105 and the target site 110 may be determined by the difference between the location coordinates defining the physical location of the launch and target sites 105, 110. Based on the distance determined between each of the launch sites 105 and the target site 110, a carrier frequency is selected to modulate the portion of data that is to be transmitted from each launch site 105 to the target site 110. Generally, the greater the distance between the launch site 105 and the target site 110, the lower the frequency used for transmission is selected. On the other hand, the shorter the distance between the launch and target sites 105, 110, the higher the frequency used for transmission between the launch and target sites 105, 110 is selected. Examples include extremely low frequencies (ELF) extending from 30 Hz to 10000 Hz with wavelengths ranging from 6209.5 miles to 18.6 miles; very low frequencies (VLF) extending from 10 kHz to 100 kHz with wavelengths ranging from 98357.9 feet to 9835.8 feet; low frequencies (LF) extending from 100 kHz to 1000 kHz with wavelengths ranging from 9835.8 ft to 983.6 fit; medium frequencies (MF) extending from 1 MHz to 3 MHz with wavelengths ranging from 983.6 feet to 327.9 feet; and high frequencies (HF) extending from 3 MHz to 30 MHz with wavelengths ranging from 327.9 feet to 32.8 feet. The HF frequencies are conducive to ‘skipping’ depending upon known solar characteristics allowing them to be used over much greater coherence distances. Other examples include very high frequencies (VHF) extending from 30 MHz to 300 MHz with wavelengths ranging from 393.4 inches to 39.3 inches and ultra high frequencies (UHF) extending from 300 MHz to 1000 MHz with wavelengths ranging from 39.3 inches to 11.8 inches.

At block 625, the precise carrier frequencies that are used for the transmission of each of the RF bit streams between each of the plurality of launch sites 105 and the target site 110 is determined. The secure message is then transmitted with the payload being distributed into the plurality of RF bit streams among the multiple launch sites 105 at block 630. Subsequent to the transmission of the RF bit streams from the launch sites 105, the RF bit streams are received and assembled at the target site 110 to recover the entire transmitted payload.

The determination of the distance between each of the plurality of launch sites 105 and the target site 110 and the specific carrier frequencies for use between a particular launch site 105 and the target site 110 will be discussed in detail according to one embodiment of the present invention. The exact distance in feet from each launch site 105 to the target site 110 is calculated by using the exact coordinates measured with the location determination unit 230 at the launch site 105 and the location determination unit 325 at the target site 110. As previously mentioned, the location determination units 230, 325 of the respective launch and target sites 105, 110 take the form of commercially available GPS receivers. Generally, the reading on the GPS receivers in milliseconds is the most accurate, and the reading in milliseconds is divided by 3,600,000 to derive the location coordinates of the launch and target sites 105, 110 in decimal. The launch site's 105 decimal latitude and longitude coordinates in degrees launchdeclat and launchdeclon are converted into radians yielding launchradlat and launchradlon as shown by the equations (1) and (2).

launchradlat n=launchdeclat n (deg)*(π/180) (1)

launchradlon n=launchdeclon n (deg)*(π/180) (2)

The target site's 110 decimal latitude and longitude coordinates in degrees targetdeclon are converted into radians targetradlat and targetradlon as shown by the equations (3) and (4).

targetradlat n=targetdeclat n (deg)*(π/180) (3)

targetradlon n=targetdeclon n (deg)*(π/180) (4)

The absolute value of the difference of the longitude (in radians) of the target site 110 targetradlon and launch site 105 launchradlon is determined providing that the difference between the longitude (in radians) of the target site 110 targetradlon and launch site 105 launchradlon is less than or equal to π/2. If not, then absolute value of the difference of the longitude (in radians) of the target site 110 targetradlon and launch site 105 launchradlon is subtracted from π (as shown by equations (5) and (6)).

L=ABS[targetradlon n−launchradlon n]{if targetradlon n−launchradlon n≦(π/2)} (5)

L=π−ABS[targetradlon n−launchradlon n]{otherwise} (6)

The sine of launchradlat and targetradlat is multiplied and added to the result of the multiplication of the cosine of launchradlon, targetradlon, and “L” (that was obtained by either equations (5) or (6) above) using equation (7) below.

C=SIN(launchradlat n)*SIN(targetradlat n)+COS(launchradlon n)*COS(targetradlon n)*COS(L) (7)

The arccosine of “C” from equation (7) is determined by equation (8) below.

θ=ACOS(C) (8)

The distance in feet between the launch site 105 and the target site 110 is determined by multiplying the result obtained from equation (8) above by 20902802.4606972 as shown by equation (9) below.

Distance n (ft)=θ*20902802.4606972 (9)

The lowest acceptable frequency freqa in MHz that may be used by any one of the launch sites 105 is selected. Estimating the distance to the target site 110 and selecting the appropriate frequency based upon wavelength determine this lowest frequency. For example, to communicate with a surface ship 3500 miles away, it would be desirable to select extremely low frequencies or high frequencies using ‘skip’ zones. The distance (in feet) between one of the launch sites 105 and the target site 110 determined from equation (9) above is multiplied by the lowest acceptable frequency freqa divided by 983.578992 (derived from the speed of light) and the result is rounded up to the nearest integer using equation (10) below.

intl=(Distance (ft)*freqa)/983.578992 (10)

The first frequency freql that is used between the first launch site 105 is calculated by multiplying 983.578992 by intl and dividing the result by the distance between the launch site 105 and the target site 110 as shown by equation (11) below.

freql=(983.578992*intl)/Distance (ft) n (11)

An interim frequency freqb is determined by equation (12) below by multiplying the first frequency determined by equation (11) by a first multiplier multl. This multiplier is selected so as not to exceed the normal propagation distance to the target site 110 (i.e., if the lowest frequency is in the range of 300 Hz to communicate with a very distant target site 110, a first multiplier selection of 100 would exceed the normal propagation distance to the target site 110.

freqb=multl*freql (12)

An interim wavelength lambdal is then determined by dividing 983.578992 by the interim frequency freqb by the equation (13) shown below.

lambdal=983.578992/freqb (13)

An interim step value interiml is then calculated by dividing the distance between the second launch site 105 and the target site 110 by the interim wavelength lambdal as shown by equation (14) below.

interiml=Distance n+1 (ft)/lambdal (14)

The interim step value interiml is rounded up to the nearest integer and set equal to int2. The second frequency freq2 that is used between the second launch site 105 is calculated by multiplying 983.578992 by int2 and dividing the result by the distance between the second launch site 105 and the target site 110 (as shown by equation (15) below).

freq2=(983.578992*int2)/Distance n+1 (ft) (15)

An interim frequency freqc is determined by multiplying the first frequency determined by equation (11) by a second multiplier mult2. This multiplier is selected in a similar manner to the selection of the first multiplier and is selected in such a way to not exceed the normal propagation distance to the target site 110.

freqc=mult2*freql (16)

An interim wavelength lambda2 is determined by dividing 983.578992 by the interim frequency freqc as shown by equation (17) below.

lambda2=983.578992/freqc (17)

An interim step value interim2 is then calculated by dividing the distance between the third launch site 105 and the target site 110 by the interim wavelength lambda2 as shown by equation (18) below.

interim2=Distance n+2 (ft)/lambda2 (18)

The interim step value interim2 is rounded up to the nearest integer and set equal to int3. The third frequency freq3 that is used between the third launch site 105 is calculated by multiplying 983.578992 by int3 and dividing the result by the distance between the third launch site 105 and the target site 110 (as shown by equation (19) below).

freq3=(983.578992*int3)/Distance n+2 (ft) (19)

If more than three launch sites 105 are being used to transmit the secure message to the target site 110, the carrier frequencies used for each additional launch site 105 may be determined by calculating an interim frequency, interim wavelength, interim step value using the same equations provided above. Once the particular carrier frequencies are obtained for each of the launch sites 105, it will modulate its portion of the divided payload on the particular carrier frequency that was assigned to the launch site 105. The transmitted signals of all the launch sites 105 will be substantially in phase at the location of the target site 110 (i.e., within the coherence circle 520 of FIG. 5), thereby enabling the target site 110 to receive all of the transmitted RF bit streams from each respective launch site 105.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
selecting a plurality of launch sites for transmitting a message to a target site;
determining a distance between each of the launch sites and the target site;
determining a carrier frequency to be respectively used by each of the launch sites, the
carrier frequency being different for each respective launch site; and transmitting the message from the launch sites to the target site using the respective
carrier frequency determined for each of the plurality of launch sites.

2. The method of claim 1, further comprising:
determining a location of the plurality of launch sites and the target site.

3. The method of claim 2, wherein determining a distance further comprises:
determining a distance between each of the launch sites and the target site based at
least on the location of the pluraility of launch sites and target site.

4. The method of claim 2, wherein determining a location of the plurality of launch sites and the target site further comprises:
determining a location of the launch sites and the target site using a global positioning system (GPS) receiver.

5. The method of claim 1, wherein selecting a plurality of launch sites for transmitting a message to a target site further comprises:
dividing the message into a plurality of bit streams; and
assigning each bit stream of the divided message to a respective launch site for transmission thereby.

6. The method of claim 1, wherein determining a carrier frequency to be respectively used by each of the plurality of launch sites further comprises:
determining a carrier frequency to be respectively used by each of the plurality of launch sites that will cause each respectively transmitted signal to be substantially in phase at the location of the target site.

7. The method of claim 5, further comprising:
receiving each bit stream transmitted by each respective launch site at the target site; and
assembling each received bit stream into the message.

8. A system, comprising:
a plurality of launch sites for transmitting a message;
a switch coupling the plurality of launch sites; and
a target site for receiving the message via a wireless communication link;
wherein the switch selects the plurality of launch sites for transmitting a message to a target site, determines a distance between each of the launch sites and the target site, determines a carrier frequency to be respectively used by each of the launch sites, the carrier frequency being different for each respective launch site; and
wherein the launch sites transmit the message to the target site using the respective carrier frequency determined for each of the plurality of launch sites.

9. The system of claim 8, wherein the plurality of launch sites and the target site determine their respective location within the system.

10. The system of claim 9, wherein the switch determines a distance between each of the launch sites and the target site based at least on the respective location of the launch sites and target site.

11. The system of claim 9, wherein the plurality of launch sites and the target site determine their respective location using a global positioning system (GPS) receiver.

12. The system of claim 8, wherein the switch divides the message into a plurality of bit streams, and assigns each bit stream of the divided message to a respective launch site for transmission thereby.

13. The system of claim 8, wherein the switch determines a carrier frequency to be respectively used by each of the plurality of launch sites that will cause each respectively transmitted signal to be substantially in phase at the location of the target site.

14. The system of claim 12, wherein the target site receives each bit stream transmitted by each respective launch site, and assembles each received bit stream into the message.

15. A switch within a wireless communication system for assigning a plurality of carrier frequencies to a plurality of launch sites for the transmission of a message to a target site, comprising:
a plurality of interfaces for communicatively coupling the plurality of launch sites to the switch; and
a controller for selecting the plurality of launch sites for transmitting a message to a target site, determining a distance between each of the launch sites and the target site, determining a carrier frequency to be respectively used by each of the plurality of launch sites, the carrier frequency being different for each respective launch site, and transmitting the message from the plurality of launch sites to the target site using the respective carrier frequency determined for each of the plurality of launch sites.

16. The switch of claim 15, wherein the controller receives location information on the location of the plurality of launch sites and the target site within the system.

17. The switch of claim 16, wherein the controller further determines a distance between each of the launch sites and the target site based at least on the respective location information of the plurality of launch sites and target site.

18. The switch of claim 16, wherein the plurality of launch sites and the target site determine their respective location information using a global positioning system (GPS) receiver.

19. The switch of claim 15, wherein the controller further divides the message into a plurality of bit streams, and assigns each bit stream of the divided message to a respective launch site for transmission thereby.

20. The switch of claim 15, wherein the controller further determines a carrier frequency to be respectively used by each of the plurality of launch sites that will cause each respectively transmitted signal to be substantially in phase at the location of the target site.

21. The switch of claim 19, wherein the target site receives each bit stream transmitted by each respective launch site, and assembles each received bit stream into the message.

22. A target site within a wireless communication system for receiving a message via a plurality of launch sites that are coupled to a target control point, comprising:
a receiver for receiving the message collectively from the plurality of launch sites; and
a controller for controlling the target site; and
wherein the target control point selects the plurality of launch sites for transmitting the message to the target site, determines a distance between each of the launch sites and the target site, determines a carrier frequency to be respectively used by each of the plurality of launch sites, the carrier frequency being different for each respective launch site, and transmits the message from the plurality of launch sites to the target site using the respective carrier frequency determined for each of the plurality of launch sites.

23. The target site of claim 22, further comprising:
a location determination unit for determining the location of the target site within the wireless communication system; and
wherein the target control point receives location information on the location of the plurality of launch sites and the target site within the wireless communication system.

24. The target site of claim 23, wherein the target control point further determines a distance between each of the launch sites and the target site based at least on the respective location information of the plurality of launch sites and target site.

25. The target site of claim 23, wherein the location determination unit comprises a global positioning system (GPS) receiver.

26. The target site of claim 22, wherein the target control point further divides the message into a plurality of bit streams, and assigns each bit stream of the divided message to a respective launch site for transmission thereby.

27. The target site of claim 22, wherein the target control point further determines a carrier frequency to be respectively used by each of the plurality of launch sites that will cause each respectively transmitted signal to be substantially in phase at the location of the target site.

28. The target site of claim 26, wherein the receiver receives each bit stream transmitted by each respective launch site, and assembles each received bit stream into the message.

29. A launch site of a plurality of launch sites coupled to a target control point within a wireless communication system for transmitting at least a portion of a message to a target site, comprising:
a transmitter for transmitting at least a portion of the message from the launch site to the target site; and
a controller for controlling the launch site; and
wherein the target control point selects the plurality of launch sites for transmitting the message to the target site, determines a distance between each of the launch sites and the target site, determines a carrier frequency to be respectively used by each of the plurality of launch sites, the carrier frequency being different for each respective launch site, and
wherein the transmitter transmits at least a portion of the message from the launch site to the target site using the carrier frequency determined by the target control point.

30. The launch site of claim 29, further comprising:
a location determination unit for determining the location of the launch site within the wireless communication system; and
wherein the target control point receives location information on the location of the plurality of launch sites and the target site within the wireless communication system.

31. The launch site of claim 29, wherein the target control point further determines a distance between each of the launch sites and the target site based at least on the respective location information of the plurality of launch sites and target site.

32. The launch site of claim 30, wherein the location determination unit comprises a global positioning system (GPS) receiver.

33. The launch site of claim 29, wherein the target control point further divides the message into a plurality of bit streams, and assigns each bit stream of the divided message to a respective launch site for transmission thereby.

34. The launch site of claim 29, wherein the target control point further determines a carrier frequency to be respectively used by each of the plurality of launch sites that will cause each respectively transmitted signal to be substantially in phase at the location of the target site.

35. The launch site of claim 33, wherein the target site receives each bit stream transmitted by each respective launch site, and assembles each received bit stream into the message.
